(19) United States
(12) Patent Application Publication
(10) Pub. No.: US 2007/0147421 A1
(43) Pub. Date: Jun. 28, 2007

(54) ISATAP router for tunneling packets and method thereof

(76) Inventor: Kill-Yeon Kim, Suwon-si (KR)

Correspondence Address: Robert E. Bushnell, Suite 300, 1522 K Street, N.W., Washington, DC, 20005-1202, US

(21) Appl. No.: 11/604,711

(22) Filed: Nov. 28, 2006

(30) Foreign Application Priority Data
Dec. 27, 2005 (KR) 10-2005-0130952

(51) Int. Cl. H04J 3/16; H04L 12/56

(52) U.S. Cl. 370/466; 370/395.54

(57) ABSTRACT

An Intra-Site Automatic Tunnel Address Protocol (ISATAP) router for tunneling packets and a method thereof are provided. A private IP address of an ISATAP host and public IPv4 address information are stored in a mapping table, a public IPv4 address of a Network Address Translator (NAT), to which an IPv6 packet received from the IPv6 host is to be transmitted, is checked using the IPv6 packet and the mapping table, and the IPv6 packet is encapsulated within an IPv4 header whose destination address is the public IPv4 address of the Network Address Translator (NAT), and tunneled to the Network Address Translator (NAT). Thus, the ISATAP host and the IPv6 network can be connected without changing the Network Address Translator (NAT).

### CLAIM OF PRIORITY

This application makes reference to, incorporates the same herein, and claims all benefits accruing under 35 U.S.C. §119 from an application for ISATAP ROUTER FOR TUNNELING PACKET AND METHOD THEREOF earlier filed in the Korean Intellectual Property Office on 27 Dec. 2005 and there duly assigned Serial No. 2005-0130952.

### BACKGROUND OF THE INVENTION

1. Field of the Invention

The present invention relates to an Intra-Site Automatic Tunnel Address Protocol (ISATAP) mechanism which is a kind of tunneling mechanism between IPv4 (Internet Protocol version 4) and IPv6 (Internet Protocol version 6).

2. Description of the Related Art

Most current Internet services are based on IPv4. In IPv4, a source terminal transmits packets including source and destination addresses to a destination on Internet. An IP address used in IPv4 is formed of 32 bits, so that a maximum of about 4 billion hosts can connect to the Internet. However, because of using a special address, subnetting and network address assignment, in actuality, the number of hosts that can connect to the Internet is considerably few. Further, as use of the Internet spreads and multimedia traffic increases, there is growing demand to connect to the Internet via mobile communication terminals and information appliance terminals, as well as computers. It is true that while there is an enormous number of mobile communication terminals and information appliances such as television sets and refrigerators, there are too few IPv4 addresses remaining to enable all such apparatuses to connect to the Internet.

In order to solve the problem of Internet address exhaustion, it is possible to use Network Address Translation (NAT). Since an IPv4 host in a Network Address Translator (NAT) area uses a private IP address, it is possible to connect a number of IPv4 hosts to the Internet using only a few public IPv4 addresses. Additionally, IPv6 technology has been suggested to enhance Internet performance by supplementing inefficiency of IPv4. IPv6 has an address system of 128 bits. Accordingly, it has plenty of IP addresses compared with IPv4 whose address system is only 32 bits. Meanwhile, if an address system is increased to 128 bits, contents of a routing table which is essential in determining a path in a router increase so that time needed to find a suitable path may increase. However, the address system of IPv6 is characterized by only a small time increase in finding a suitable path from the routing table since it consists of more layers than IPv4.

Since so many IPv4 systems exist currently, it seems inevitable that two types of networks using IPv4 and IPv6 will coexist for a considerably long time into the future. Accordingly, many transition mechanisms between IPv4 and IPv6 have been suggested, and the Internet Engineering Task Force (IETF) has taken on the task of standardization. Such transition schemes can be generally classified into a dual stack scheme, a tunneling scheme and a translation scheme, the tunneling scheme being the most frequently used at present.

In the dual stack scheme, a host supports both protocol stacks of IPv4 and IPv6 wherein the host uses IPv4 when connected to the IPv4 network and IPv6 when connected to the IPv6 network. The translation scheme supports an interworking between an IPv4 host and an IPv6 host facilitated by a translation protocol such as NAT-Protocol Translator (NAT-PT) which reciprocally translates the IPv4 packet and the IPv6 packet, and an Application Level Gateway (ALG) function depending on various applications.

### SUMMARY OF THE INVENTION

It is an objective of the present invention to provide a router and method for tunneling packets whereby a private IP address of an ISATAP host and public IPv4 address information of a Network Address Translator (NAT) are stored in a mapping table, a public IPv4 address of the Network Address Translator (NAT) to which an IPv6 packet received from an IPv6 host is to be transmitted is checked using the IPv6 packet and the mapping table, and the IPv6 packet is encapsulated within the IPv4 header in which the public IPv4 address of the Network Address Translator (NAT) is the destination address, and tunneled to the Network Address Translator (NAT).

According to an aspect of the present invention, there is provided a method for configuring tunneling in an IP network, comprising the steps of: transmitting, at an IPv4 host, to a Network Address Translator (NAT) a first router solicitation message including at lease one of an IPv4 header including a private IPv4 address of the IPv4 host and a public IPv4 address of a router, and an IPv6 header including private IPv4 address information of the IPv4 host; transmitting, at the Network Address Translator (NAT), to the router a second router solicitation message in which the private IPv4 address of the IPv4 host included in the IPv4 header of the first router solicitation message is replaced by a public IPv4 address of the Network Address Translator (NAT); and receiving, at the router, the second router solicitation message and store the private IPv4 address of the IPv4 host and the public IPv4 address of the Network Address Translator (NAT) included in the second router solicitation message.

The IPv6 header of the first router solicitation message may comprise a source address which is an ISATAP IPv6 address of the IPv6 host and a destination address which contains IPv6 address information of the router, and the IPv4 header of the first router solicitation message may comprise a source address which is a private IPv4 address of the IPv4 host and a destination address which contains public IPv4 address information of the router.

The method may further comprise the steps of: transmitting, at the router, to the Network Address Translator (NAT) a first router advertisement message including at least one of the IPv4 header including the public IPv4 address of the Network Address Translator (NAT) and the public IPv4 address of the router, and the IPv6 header including the private IPv4 address information of the IPv4 host; and transmitting, at the Network Address Translator (NAT), to the IPv4 host a second router advertisement message in which the public IPv4 address of the Network Address Translator (NAT) included in the IPv4 header of the first router advertisement message is replaced by the private IPv4 address of the IPv4 host.

The IPv6 header of the first router advertisement message may comprise a source address which is the IPv6 address of the router and the destination address which contains ISATAP IPv6 address information of the IPv4 host, and the IPv4 header of the first router advertisement message may comprise a source address which is the public IPv4 address of the router and a destination address which contains IPv4 address information of the Network Address Translator (NAT).

The method may further comprise the step of storing, at the router, an expiration time of the private IPv4 address of the IPv4 host and the public IPv4 address of the Network Address Translator (NAT) corresponding to the private IPv4 address of the IPv4 host.

According to another aspect of the present invention, there is provided a method for tunneling a packet from an IPv6 host to an IPv4 host, comprising the steps of: storing, at a router, a private IPv4 address of at least one IPv4 host and public IPv4 address information of a Network Address Translator (NAT) which manages the IPv4 host in a mapping table; mapping, at the router, the IPv4 address of a receiving IPv4 host included in a header of a first IPv6 packet which is received from a transmitting IPv6 host to the mapping table and to obtain a public IPv4 address of the Network Address Translator (NAT) which manages the receiving IPv4 host; transmitting, at the router, to the Network Address Translator (NAT) a first IPv4 packet which is formed by encapsulating a header including the public IPv4 address of the Network Address Translator (NAT) of the first IPv6 packet; and transmitting, at the Network Address Translator (NAT), the first IPv4 packet to the private IPv4 address of the IPv4 host.

The step of obtaining, at the router, the public IPv4 address of the Network Address Translator (NAT) may comprise the steps of: extracting, at the router, the last 32 bits of an IPv6 header destination address of the first IPv6 packet; and searching for, at the router, an entry having the same private IPv4 address of the IPv4 host as the extracted IPv4 address in the mapping table, and obtain a Network Address Translation (NAT) public IPv4 address included in the searched entry.

The method may further comprise the step of, when there is no entry having the same private IPv4 address of the IPv4 host as the extracted IPv4 address, encapsulating, at the router, the header of the first IPv6 packet including the stored IPv4 address.

The method may further comprise the steps of: transmitting, at the IPv4 host, to the Network Address Translator (NAT) a second IPv4 packet including at least one of the IPv4 header including an IPv4 address of the IPv4 host and a public IPv4 address of the router, the IPv6 header including the private IPv4 address of the IPv4 host and the IPv6 address of the IPv6 host, and data; replacing, at the Network Address Translator (NAT), the public IPv4 address of the IPv4 host included in the second IPv4 header by the public IPv4 address of the Network Address Translator (NAT) and transmit the public IPv4 address to the router; and transmitting, at the router, a second IPv6 packet which is made by decapsulating the second IPv4 header to the IPv6 address of the IPv6 host included in the second IPv6 header.

According to still another aspect of the present invention, there is provided a method for tunneling a packet from an IPv6 host to an IPv4 host, comprising the steps of: transmitting, at an IPv4 host, to a Network Address Translator (NAT) a first router solicitation message including at lease one of an IPv4 header including a private IPv4 address of the IPv4 host and a public IPv4 address of a router, and an IPv6 header including private IPv4 address information of the IPv4 host; transmitting, at the Network Address Translator (NAT), to the router a second router solicitation message in which the private IPv4 address of the IPv4 host included in the IPv4 header of the first router solicitation message is replaced by a public IPv4 address of the Network Address Translator (NAT); receiving, at the router, the second router solicitation message and store the private IPv4 address of the IPv4 host and the public IPv4 address of the Network Address Translator (NAT) included in the second router solicitation message in a mapping table; transmitting, at the router, to the Network Address Translator (NAT) a first router advertisement message including at least one of the IPv4 header including the public IPv4 address of the Network Address Translator (NAT) and the public IPv4 address of the router, and the IPv6 header including the private IPv4 address information of the IPv4 host; transmitting, at the Network Address Translator (NAT), to the IPv4 host a second router advertisement message in which the public IPv4 address of the Network Address Translator (NAT) included in the IPv4 header of the first router advertisement message is replaced by the private IPv4 address of the IPv4 host; storing, at a router, a private IPv4 address of at least one IPv4 host and public IPv4 address information of a Network Address Translator (NAT) which controls the IPv4 host in a mapping table; mapping, at the router, the IPv4 address of a receiving IPv4 host included in a header of a first IPv6 packet which is received from a transmitting IPv6 host to the mapping table and to obtain a public IPv4 address of the Network Address Translator (NAT) which manages the receiving IPv4 host; transmitting, at the router, to the Network Address Translator (NAT) a first IPv4 packet which is formed by encapsulating a header including the public IPv4 address of the Network Address Translator (NAT) of the first IPv6 packet; and transmitting, at the Network Address Translator (NAT), the first IPv4 packet to the private IPv4 address of the IPv4 host.

The method may further comprise the steps of: transmitting, at the IPv4 host, to the Network Address Translator (NAT) a second IPv4 packet including at least one of the IPv4 header including an IPv4 address of the IPv4 host and a public IPv4 address of the router, the IPv6 header including the private IPv4 address of the IPv4 host and the IPv6 address of the IPv6 host, and data; replacing, at the Network Address Translator (NAT), the public IPv4 address of the IPv4 host included in the second IPv4 header by the public IPv4 address of the Network Address Translator (NAT) and transmit the public IPv4 address to the router; and transmitting, at the router, a second IPv6 packet which is made by decapsulating the second IPv4 header to the IPv6 address of the IPv6 host included in the second IPv6 header.

According to yet another aspect of the present invention, there is provided a router for managing at least one IPv4 host and a Network Address Translator (NAT), comprising a mapping table including at least one entry which includes a private IPv4 address of the IPv4 host and a public IPv4 address of a Network Address Translator (NAT) which manages the IPv4 host; a mapping module for extracting an IPv4 address of a destination IPv4 host from a first IPv6 packet received from an IPv6 host, and searching for a public IPv4 address of the Network Address Translator (NAT) which manages the destination IPv4 host in the mapping table; a packet conversion module for encapsulating the first IPv6 packet within an IPv4 header including the searched Network Address Translator (NAT) public IPv4 address and converting the encapsulated first IPv6 packet into a first IPv4 packet; and a communication module for transmitting the converted first IPv4 packet to the public IP address of the Network Address Translator (NAT).

The packet conversion module may receive the second IPv4 packet to be transmitted from the IPv4 host to the IPv6 host from the Network Address Translator (NAT), decapsulate the second IPv4 header included in the second IPv4 packet and convert the decapsulated IPv4 header into the second IPv6 packet; and the communication module may transmit the converted second IPv6 packet to the IPv6 address of the IPv6 host included in the second IPv6 packet.

The mapping table may additionally store an expiration time of each entry, and the router may further comprise a mapping table management module for checking whether the expiration time stored in the mapping table has lapsed, and deleting an entry whose expiration time has lapsed.

According to yet another aspect of the present invention, there is provided an IP network having an IPv4 host used to communicate with an IPv6 host, comprising a router for storing a private IPv4 address of at least one IPv4 host and public IPv4 address information of a Network Address Translator (NAT) which manages the IPv4 host in a mapping table, mapping the IPv4 address of a destination IPv4 host included in a first IPv6 header of a first IPv6 packet which is received from the IPv6 host to the mapping table, obtaining a public IPv4 address of the Network Address Translator (NAT) which manages the destination IPv4 host, and transmitting to the Network Address Translator (NAT) a first IPv4 packet which is formed by encapsulating the first IPv6 packet within an IPv4 header including the Network Address Translator (NAT) public IPv4 address; and a Network Address Translator (NAT) for transmitting a second IPv4 packet whose address is replaced by a private IPv4 address of the IPv4 host included in the first IPv6 header of the first IPv4 packet to the IPv4 host.

The router may extract the last 32 bits of an IPv6 header destination address from the received first IPv6 packet, and may store a private IPv4 address of at least one IPv4 host and public IPv4 address information of a Network Address Translator (NAT) which manages the IPv4 host in a mapping table, search for an entry having the same private IPv4 address as the extracted IPv4 address in the mapping table, and obtain a Network Address Translator (NAT) public IPv4 address which manages the IPv4 host. When there is no entry having the same private IPv4 address of the IPv4 host as the extracted IPv4 address, the router may encapsulate the header of the first IPv6 packet including the extracted IPv4 address.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram of an IPv4/IPv6 transition mechanism using a tunneling scheme;

FIG. 2 is a block diagram of an IPv4/IPv6 transition mechanism using an Intra-Site Automatic Tunnel Address Protocol (ISATAP) tunneling scheme;

FIG. 3 is a block diagram illustrating an address format of an IPv6 packet used in an ISATAP tunneling scheme;

FIG. 4 is a flowchart illustrating a method of transmitting and receiving a data packet between an ISATAP host and an IPv6 host through an ISATAP router;

FIG. 5 is a flowchart illustrating a problem occurring when RS/RA (Router Solicitation/Router Advertisement) messages are transmitted and received using a general ISATAP router in a network in which a Network Address Translator (NAT) is used;

FIG. 6 is a flowchart illustrating a problem occurring when data packets are transmitted using a general ISATAP router in a network in which a Network Address Translator (NAT) is used;

FIG. 7 is a block diagram showing an internal configuration of an ISATAP router in accordance with an exemplary embodiment of the present invention;

FIG. 8 is a flowchart illustrating a method by which an ISATAP router configures a mapping table using an Router Solicitation (RS) message;

FIG. 9 is a flowchart illustrating an example of a mapping table configured according to a mapping table configuration method in accordance with an exemplary embodiment of the present invention;

FIG. 10 is a flowchart illustrating a process whereby an ISATAP router transmits an Network Address Translator (NAT) message to an ISATAP host in accordance with an exemplary embodiment of the present invention;

FIG. 11 is a flowchart illustrating a method by which an ISATAP router transmits an IPv6 packet to a Network Address Translator (NAT) in accordance with an exemplary embodiment of the present invention; and

FIG. 12 is a flowchart illustrating steps where an ISATAP host in a Network Address Translator (NAT) area transmits and receives data packets to and from an IPv6 host in accordance with an exemplary embodiment of the present invention.

### DETAILED DESCRIPTION OF EXEMPLARY EMBODIMENTS

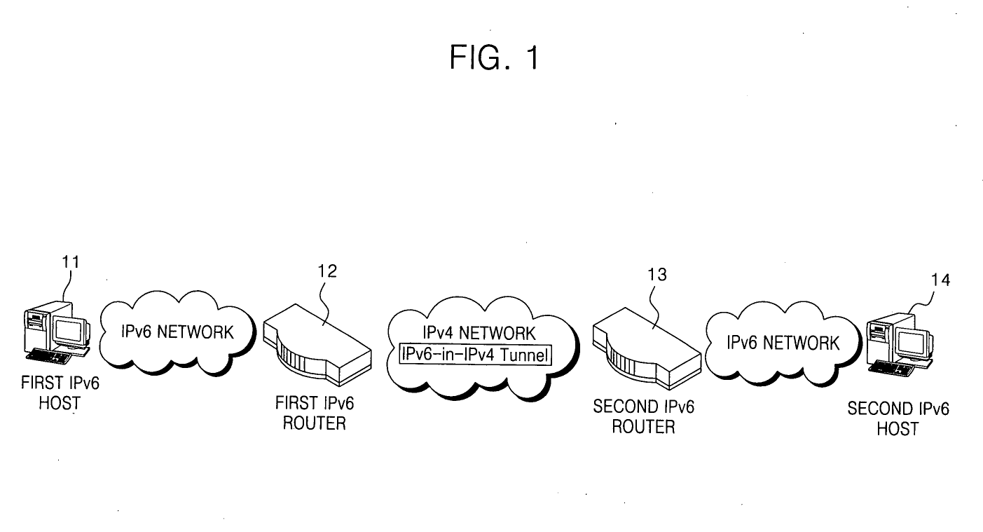

FIG. 1 is a block diagram of an IPv4/IPv6 transition mechanism using a tunneling scheme.

As shown in FIG. 1, the tunneling scheme is used when two IPv6 hosts 11 and 14 connected to different IPv6 networks can only communicate with each other by way of an IPv4 network.

A method of transmitting IPv6 packets from the first IPv6 host 11 to the second IPv6 host 14 using the tunneling scheme of FIG. 1 will be described below.

The first IPv6 router 12 receives the IPv6 packet from the IPv6 host 11, encapsulates the IPv6 packet within an IPv4 header and translates it into an IPv4 packet. The IPv4 packet is transmitted to the second IPv6 router 13 by way of the IPv4 network. The second IPv6 router 13 translates the IPv4 packet into the IPv6 packet by decapsulating the IPv4 header, and transfers the translated packet to the second IPv6 host 14 through the IPv6 network.

Such tunneling schemes can also be divided into Configured Tunnel, Automatic Tunnel, 6 to 4 Tunnel and ISATAP schemes.

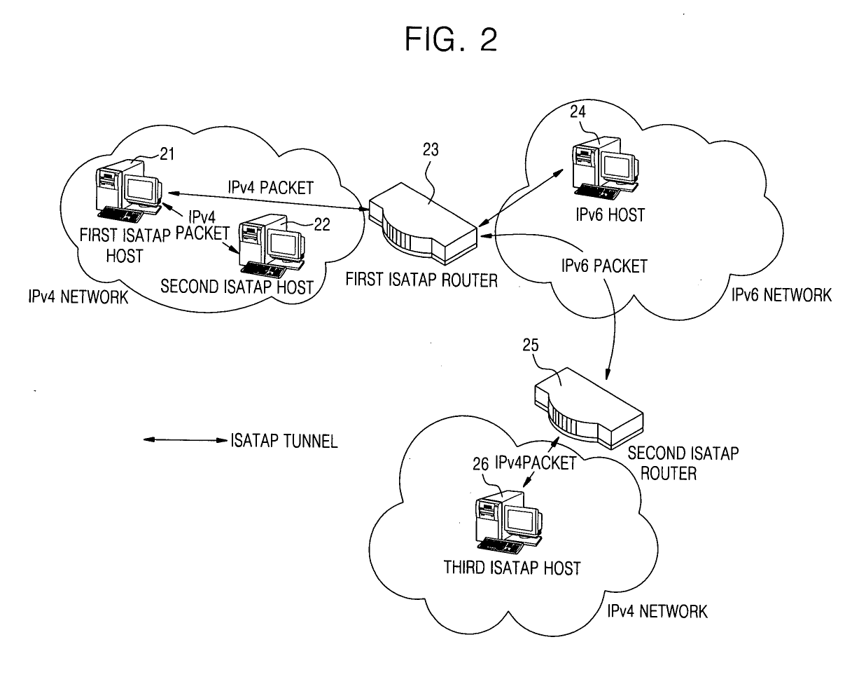

FIG. 2 is a block diagram showing an IPv4/IPv6 transition mechanism using an ISATAP tunneling scheme.

An Intra-Site Automatic Tunnel Address Protocol (ISATAP) scheme is a kind of automatic tunneling scheme. The ISATAP scheme is characterized in that it generates an IPv6 address using a subnet prefix or a global IPv6 prefix without a fixed IPv6 prefix, which is different from other automatic tunneling schemes.

ISATAP tunneling is mainly used between ISATAP hosts 21 and 22, or between ISATAP hosts 21, 22 and 26 and ISATAP routers 23 and 25 in an ISATAP network. In order to transmit an IPv6 data packet in an IPv4 network, the IPv6 packet should be encapsulated within an IPv4 header and transmitted as described above. Using such a scheme, the IPv6 packet can be transmitted by using the ISATAP scheme even when a local network is an IPv4 network. A method of communication between the ISATAP host and an IPv6 host 24 in an IPv6 network or an ISATAP host in another network will be described below by way of an example. First of all, an address format of the IPv6 packet used in the ISATAP tunneling scheme will be described.

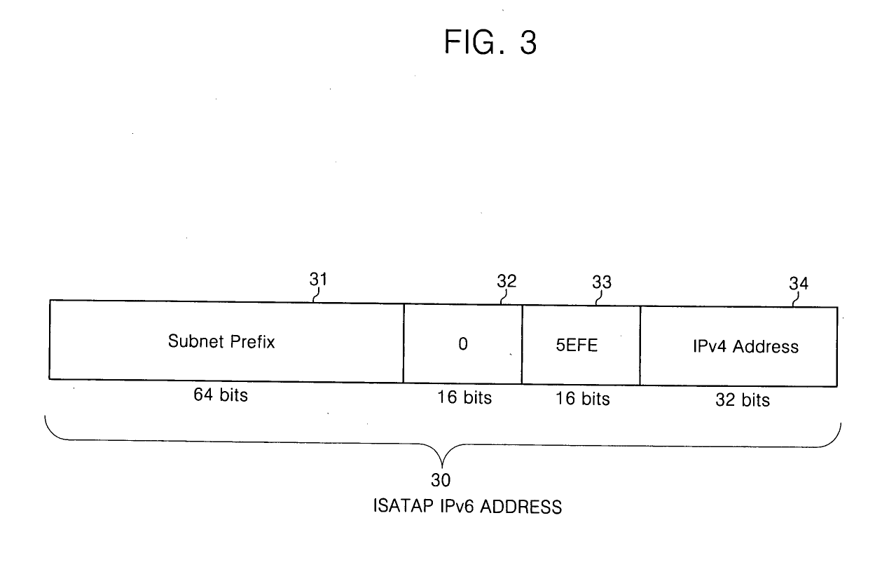

FIG. 3 is a block diagram showing an address format of an IPv6 packet used in an ISATAP tunneling scheme.

An IP address based on IPv6 consists of a total of 128 bits. Accordingly, an address 30 of the IPv6 packet used in the ISATAP tunneling scheme also consists of a total of 128 bits. ISATAP IPv6 address 30 consists of a subnet prefix (global IPv6 prefix) 31, a 0000 field 32, a 5EFE field 33, and an IPv4 address field 34.

The subnet prefix 31 consists of 64 bits. In this case, the subnet prefix 31 is an address of a network to which the ISATAP host belongs. The ISATAP host transmits a Unicast Router Solicitation (RS) message to the ISATAP router in order to obtain subnet prefix information that the host requires. The ISATAP router informs the ISATAP host of the subnet prefix by transmitting a Router Advertisement (RA) message to the ISATAP host in response to the RS message. Of course, a user of the ISATAP host may manually configure the subnet prefix.

Further, the 0000 field 32 and the 5EEE field 33 of the IPv6 address each consist of 16 bits and denote an IPv6 packet based on ISATAP. The IPv4 address field 34 consists of 32 bits including IPv4 address information of the ISATAP host.

For example, a case will be considered where an ISATAP host having an IPv4 address of 165.213.227.1 belongs to a network which uses the subnet prefix 31 of 3FFE:2E01::/64. Here, a shortened notation of an IPv6 address expressing the ISATAP host is 3FFE:2E01::5EFE:A5D5:E301. The information 3FFE:2E01::/64 is included in the subnet prefix 31 of the IPv6 address. Further, since the ISATAP host commonly uses ISATAP, it includes a 0000 field 32 (represented by::) and a 5EFE field 33. Since the host address of the ISATAP terminal is 165.213.227.1, it can be translated (IPv4 address expressed in hexadecimal notation) into A5.D5.E3.01, which is included in the IPv4 address field 34 of the IPv6 address (A5D5:E301).

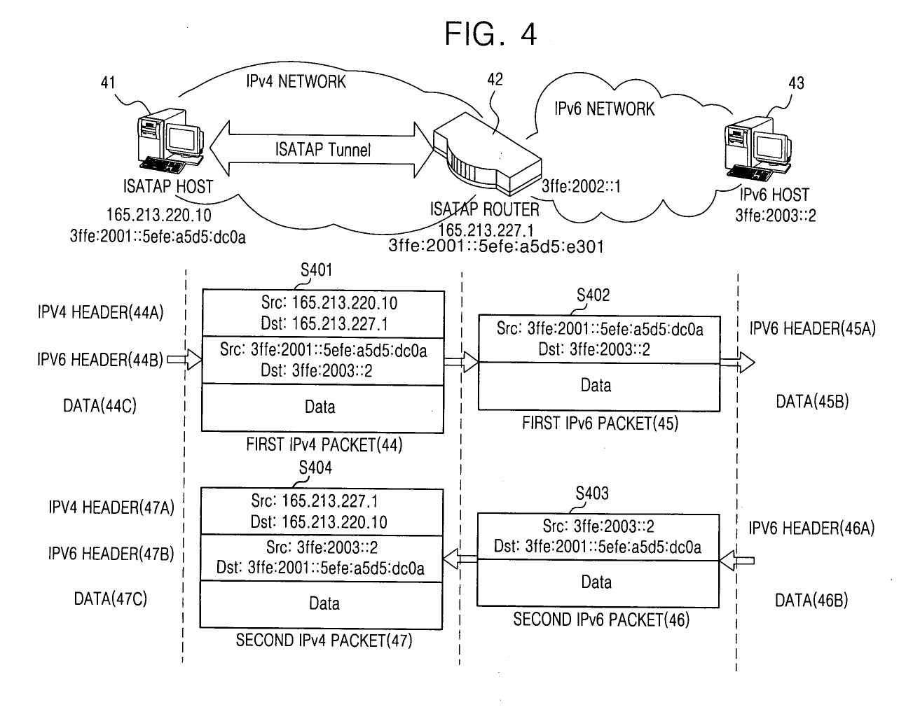

FIG. 4 is a flowchart illustrating a method of transmitting and receiving a data packet between an ISATAP host and an IPv6 host through an ISATAP router.

As shown in FIG. 4, the ISATAP network consists of an ISATAP host 41 and an ISATAP router 42, and transmits and receives packets to and from an IPv6 host 43 through an IPv6 network.

A method by which the ISATAP host transmits a data packet to the IPv6 host 43 will be considered. The ISATAP host 41 transmits a first IPv4 packet 44 to the ISATAP router (S401). At this time, the first IPv4 packet 44 is configured such that an IPv6 header 44B and data 44C are encapsulated within an IPv4 header 44A. A source address of the IPv4 header 44A is a public IPv4 address of the ISATAP host 41, and a destination address is a public IPv4 address of the ISATAP router 42. Further, a source address of the IPv6 44B has a form in which a prefix meaning an ISATAP network address and an IPv4 address are mixed (3ffe:2001::5efe:a5a5:dc0a). Meanwhile, the destination address of the IPv6 header 44B becomes an IPv6 address of the IPv6 host 43 (3ffe:2003::2).

The ISATAP router 42 transmits to the IPv6 host 43 a first IPv6 packet 45 which is decapsulated from the IPv4 header 44A of the first IPv4 packet 44 (S402). The first IPv6 packet 45 is configured with the IPv6 header 45A and the data 45B, which have the same information as the IPv6 header 44B of the first IPv4 packet 44 and the data 44C, respectively.

On the other hand, a procedure where the data packet is transmitted from the IPv6 host 43 to the ISATAP host 41 will considered. The IPv6 host 43 transmits the second IPv6 packet 46 to the ISATAP router 43 (S403). The second IPv6 packet 46 is configured with the IPv6 header 46A and the data 46B. The source address of the IPv6 header 46A is an IPv6 address of the IPv6 host 43 and the destination address is the ISATAP IPv6 address of the ISATAP host 41.

The ISATAP router 42 encapsulates the second IPv6 packet 46 within the IPv4 header 47A and transmits the encapsulated packet to the ISATAP host 41 (S404). In this case, the source address of the IPv4 header 47A becomes the IPv4 address of the ISATAP router 42, and the destination address becomes the IPv4 address of the ISATAP host 41 included in the IPv6 header 46A. The destination address of the IPv6 header 46A of the second IPv6 packet 46 has the configuration of the ISATAP IPv6 address described in FIG. 3. The ISATAP router 42 can identify the IPv4 address of the ISATAP host 41 using the last 32 bits of the destination address of the IPv6 header 46A, that is, information on the IPv4 address field.

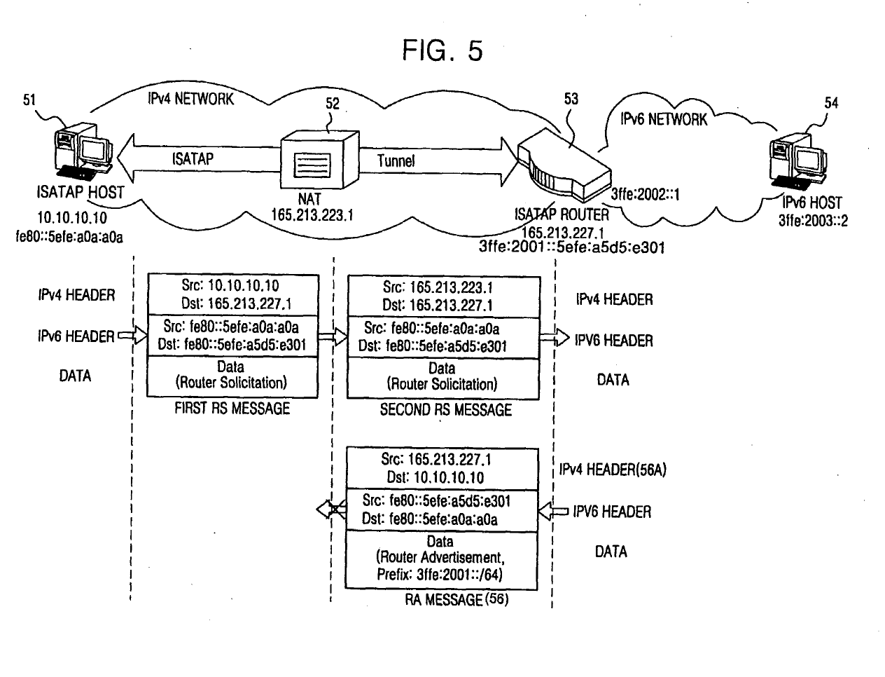

FIG. 5 is a flowchart illustrating a problem occurring when RS/RA (Router Solicitation/Router Advertisement) messages are transmitted and received using a general ISATAP router in a network in which a Network Address Translator (NAT) is used.

The network system shown in FIG. 5 shows a case where a Network Address Translator (NAT) is used in an ISATAP network. The ISATAP network can be configured with an ISATAP host 51, a Network Address Translator (NAT) 52 and an ISATAP router 53. In this case, the ISATAP host 51, included in a private network managed by the Network Address Translator (NAT) 52, transmits an RS message to the ISATAP router 53 by way of the Network Address Translator (NAT) 52. However, an RA message 56 which is a response message of the ISATAP router 53 cannot be transferred to the ISATAP host 51 by way of the Network Address Translator (NAT) 52.

This is because the destination address of the IPv4 header 56A within which the ISATAP router 53 encapsulates the RA message is the private IPv4 address of the ISATAP host 51. That is, since the RA message 56 has the private IPv4 address as a destination address, it is not possible to route the ISATAP router 53 to the Network Address Translator (NAT) 52. Accordingly, the RA message 56 cannot be transmitted to the ISATAP host 51.

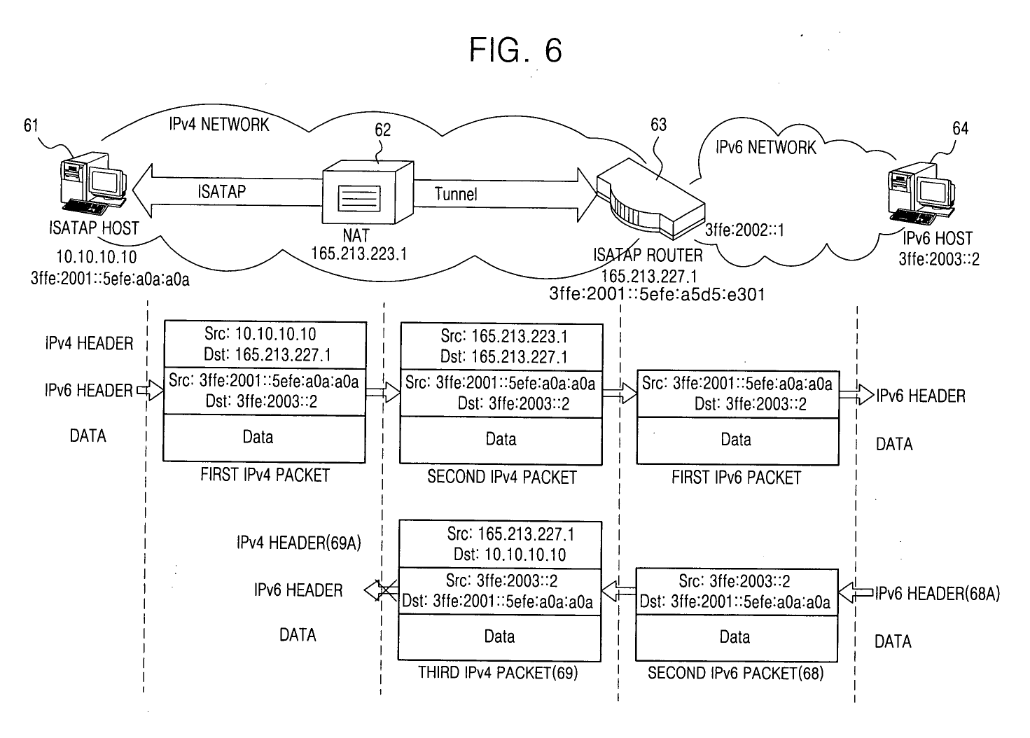

FIG. 6 is a flowchart illustrating a problem occurring when data packets are transmitted using a general ISATAP router in a network in which a Network Address Translator (NAT) is used.

As shown in FIG. 5, the ISATAP network is configured with an ISATAP host 61, a Network Address Translator (NAT) 62 and an ISATAP router 63, and tries to transmit packets to the IPv6 host 64 through the IPv6 network.

When the ISATAP router 63 transmits data packets to the Network Address Translator (NAT) 62 through the ISATAP interface, it has to encapsulate a second IPv6 packet 68 with an IPv4 header 69A. A destination address of the IPv4 header 69A used in this case uses the last 32 bits (a0a:a0a) of the destination address of the IPv6 header 68A included in the second IPv6 packet 68. Since an address of the last 32 bits of the destination address is a private IPv4 address used before the packets transmitted by the ISATAP host 61 pass through the Network Address Translator (NAT) 62, the IPv6 packet 68 is encapsulated within the IPv4 header 69A whose destination address is the private IPv4 address. Since a third IPv4 packet 69 encapsulated using such a method has no information to be routed, it cannot be transmitted from the ISATAP router 63 to the Network Address Translator (NAT) 62.

One method to solve such a problem is to process all packets encapsulated in an ISATAP tunnel of Network Address Translation (NAT) equipment. Such a method, however, entails transmission delay and a considerable load on the Network Address Translation (NAT) equipment, since the Network Address Translation (NAT) equipment has to support IPv6, all packets in the Network Address Translation (NAT) equipment have to be checked, and the packets encapsulated according to the ISATAP scheme have to be corrected. Further, while there is a method in which an IPv6 stack and a communication mechanism between the ISATAP host and the ISATAP router are corrected and information on which messages passed through a Network Address Translator (NAT) is provided from the ISATAP router to the ISATAP host, this method has a problem in that both the ISATAP host and the router should be corrected.

Hereinafter, an ISATAP router for tunneling packets in an ISATAP network including a Network Address Translator (NAT), and a method thereof, in accordance with the present invention will be described in detail with reference to the accompanying drawings.

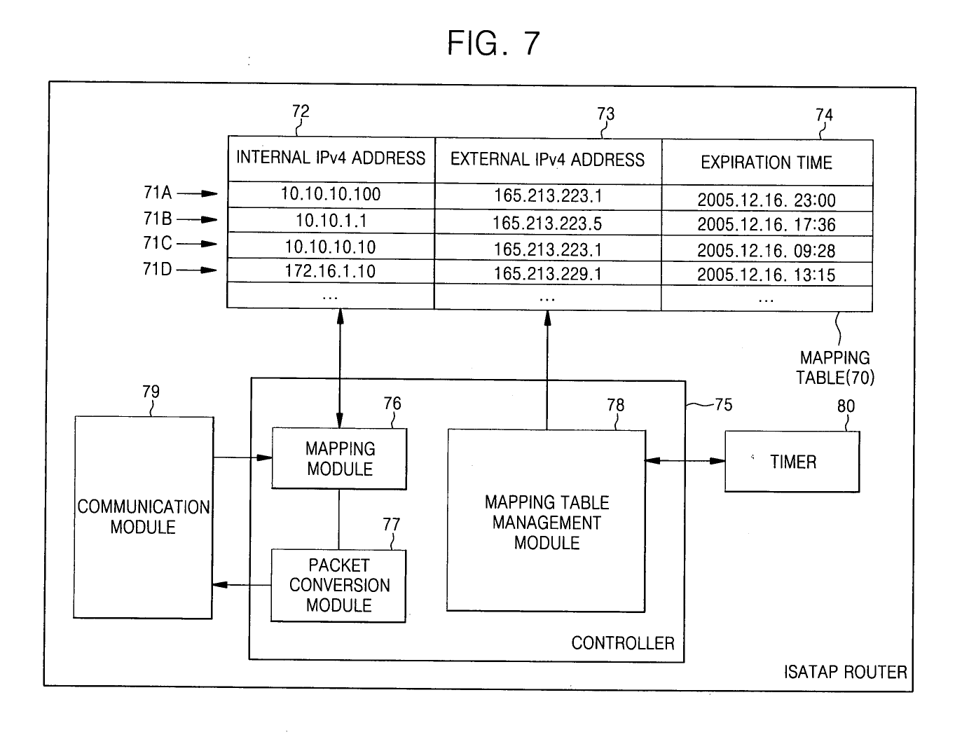

FIG. 7 is a block diagram showing an internal configuration of an ISATAP router in accordance with an exemplary embodiment of the present invention.

Referring to FIG. 7, the ISATAP router can be configured with a mapping table 70, a controller 75, a communication module 79 and a timer 80.

The mapping table 70, shown in FIG. 7, is configured of one or more entries 71A, 71B, 71C and 71D showing connections between an internal IPv4 address 72 and an external IPv4 address 73. Further, each entry has expiration time 74 so that entries 71A, 71B, 71C and 71D, whose expiration time 74 have been lapsed, are deleted from the mapping table 70. Here, the internal IPv4 address 72 is a private IPv4 address that an ISATAP host uses in a private domain existing in a Network Address Translator (NAT), and the external IPv4 address 73 is a public IPv4 address of the Network Address Translator (NAT) which manages the ISATAP host.

The communication module 79 is a network interface of the ISATAP router, which has a function of exchanging packets with the Network Address Translator (NAT), the IPv6 host, IPv4 host and router of another network.

The controller 75 can include a mapping module 76, a packet conversion module 77, and a mapping table management module 78.

The mapping module 76 extracts an IPv4 address of a destination IPv4 host included in an IPv6 packet that communication module 79 receives from the IPv6 host, and searches entries 71A, 71B, 71C and 71D for entries including the same internal IPv4 address 72 as the IPv4 address of the destination IPv4 host in the mapping table 70. When there exists an entry which satisfies the condition as a result of searching them, an external IPv4 address corresponding to the IPv4 address of the destination IPv4 host is transferred to the packet conversion module 77.

The packet conversion module 77 encapsulates the IPv6 packet received from the communication module 79 within the IPv4 header including the external IPv4 address that the mapping module has searched for. As a result of the encapsulation, the IPv6 packet is converted into the IPv4 packet.

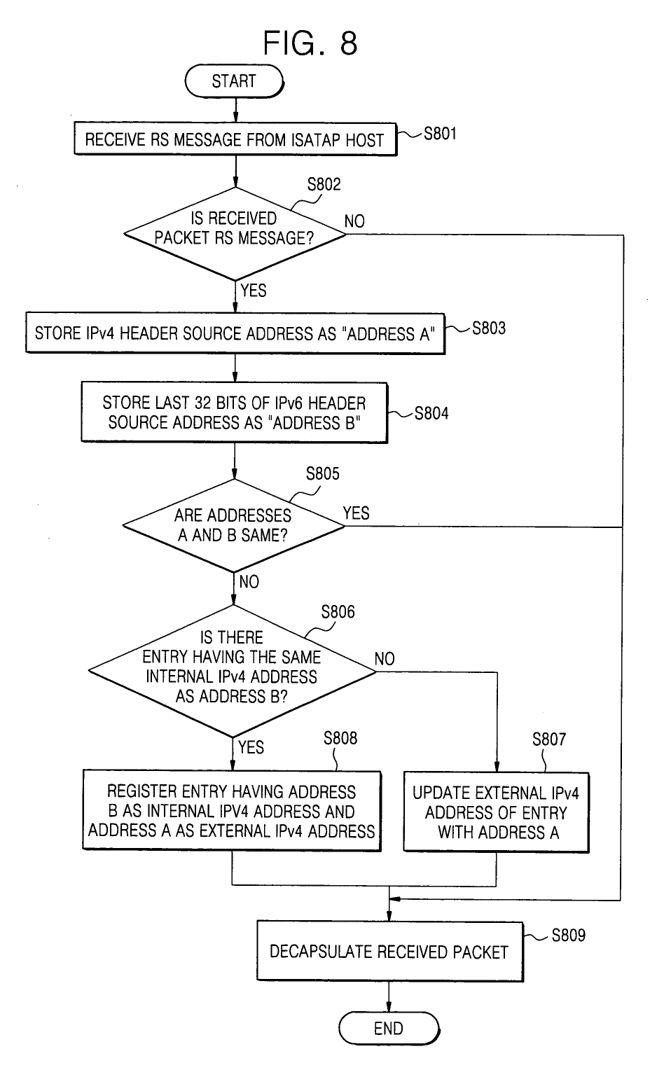

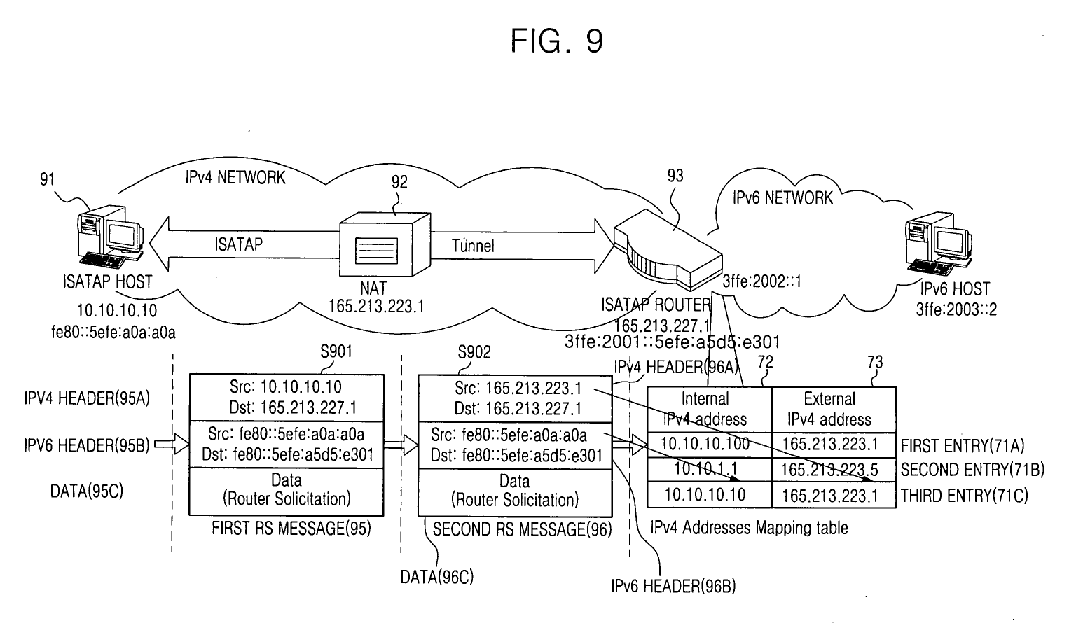

The mapping table management module 78 manages addition, correction and deletion of the entries 71A, 71B, 71C and 71D included in the mapping table. The mapping table management module 78 is connected with a timer 80, and compares expiration time 74 of the mapping table 70 with time on the timer 80 and deletes an entry whose expiration time has been lapsed. Of course, in the case that the communication module 79 receives an RS message from the IPv4 host, the mapping table management module 78 adds or updates the entry using information included in the RS message. Such a method will be described in detail with reference to FIGS. 8 and 9.

FIG. 8 is a flowchart illustrating a method by which an ISATAP router configures a mapping table using the RS message.

The ISATAP router in accordance with an embodiment of the present invention adds or changes entries of the mapping table using the RS message. It is because the ISATAP protocol provides that the ISATAP host transmits an RS message of IPv6 format to the ISATAP router and then makes a transmission of the data packet. That is, since the RS message is the first packet that the ISATAP router receives from the ISATAP host, it is possible to determine that the ISATAP host makes a transmission through a Network Address Translator (NAT) using the RS message.

The ISATAP router receives from the ISATAP host a transmitted RS message by way of the Network Address Translator (NAT) (S801). The RS message is transmitted as a packet of the IPv4 format. Then, the ISATAP router determines whether the received packet is the RS message (S802). Such a process is performed by checking a header of the received packet. If the received packet is not the RS message, the ISATAP router decapsulates the received packet using methods known in the art (S809).

If the received packet is the RS message, the ISATAP router stores a source address (hereinafter, referred to as “address A”) of the IPv4 header included in the received RS message as the external IPv4 address (S803). Further, the ISATAP router extracts the last 32 bits among the source address of IPv6 format of the IPv6 header included in the RS message, that is, the IPv4 field in FIG. 3 (hereinafter, referred to as “address B”) and stores it as the internal IPv4 address.

The ISATAP router determines whether the address A in step S803 is the same as the address B in step S804 (S805). If the addresses A and B are same, the RS message does not pass through the Network Address Translator (NAT) so that the problem described in FIG. 5 or 6 is not occurred. Therefore, the mapping table is not updated and the step progresses to step S809 and the ISATAP router decapsulates the received packet using methods known in the art.

If the addresses A and B are different with each other, the ISATAP router can realize that the RS message is transmitted by way of the Network Address Translator (NAT), and updates the mapping table.

The ISATAP router searches for whether there exists an entry having the same internal IPv4 address 72 as the address B in the mapping table (S806). When the same entry exists as a result of the search, it may be the case that information on the entry of the mapping table was corrected, so that an external IPv4 address 73 of the mapping table is updated with the address A and the expiration time 74 is reset (S807). When the same entry does not exist, the ISATAP router has the value of the address A as the external IPv4 address, and registers a new entry having the value of the address B as the internal IPv4 (S808). Of course, expiration time is set according to a user's setting. Then, the ISATAP router decapsulates the received packet using methods known in the art (S809).

Hereinbefore, while the method by which to configure the mapping table using the RS message between the ISATAP host and the router was described, those skilled in the art can generate the mapping table with ease using the packet including the private IPv4 address of the ISATAP host and the public IPv4 address of the Network Address Translator (NAT) which manages the private IPv4 address as well as the RS message.

FIG. 9 is a flowchart illustrating an example of a mapping table configured according to a mapping table configuration method in accordance with an exemplary embodiment of the present invention.

Referring to FIG. 9, the ISATAP network can be configured with an ISATAP host 91, a Network Address Translator (NAT) 92 and an ISATAP router 93. At this time, the ISATAP host 91 has a private IPv4 address of 10.10.10.10 and the Network Address Translator (NAT) 92 has a public IPv4 address of 165.213.223.1. The ISATAP router 93 has a public IPv4 address of 165.213.227.1 and an IPv6 address of 3ffe:2001::5efe:a5d5:e301. Accordingly, a subnet prefix which is an address of the ISATAP network is 3ffe:2001::/64.

The ISATAP host 91 transmits a first RS message 95 to the Network Address Translator (NAT) 92 (S901). The first RS message 95 is configured with an IPv4 header 95A, an IPv6 header 95B and data 95C. A source address of the IPv4 header 95A is 10.10.10.10, and its destination address is 165.213.227.1. A source address of the IPv6 header 95B is fe80::5efe:a0a:a0a, and its destination address is fe80::5efe:a5d5:e301. A data (95C) portion of the first RS message includes information indicating the RS message.

The Network Address Translator (NAT) 92 transmits to the ISATAP router 93 a second RS message 96 which is formed by translating the source address 10.10.10.10 of the IPv4 header 95A of the first RS message 95 into the public IPv4 address 165.213.223.1 of the Network Address Translator (NAT) (S902).

The ISATAP router 93 receives the second RS message 96 and registers it in a third entry of the mapping tale using the method descried in FIG. 8. In more detail, a value of a0a:a0a (address B) that is a decimal number converted from a0a:a0a of the IPv4 address field being the last 32 bits of the source address of the IPv6 header is stored in the internal IPv4 address 72, and the source address 165.213.223.1 (address A) of the IPv4 header is stored in the external IPv4 address 73.

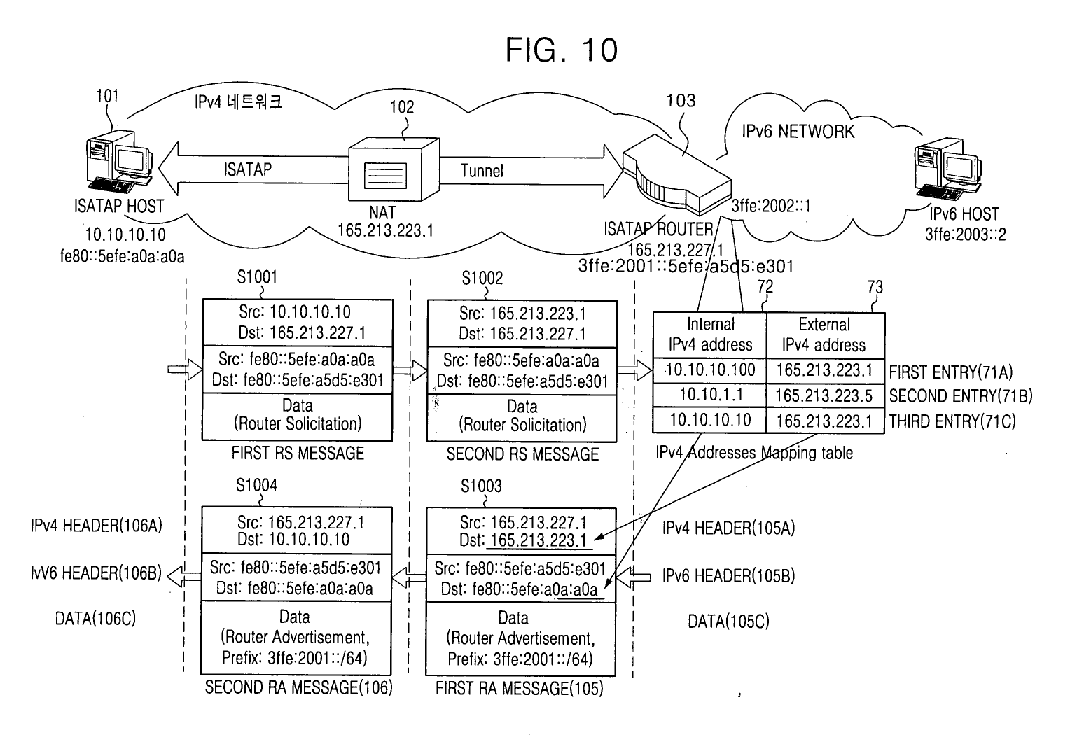

FIG. 10 is a flowchart illustrating a process whereby an ISATAP router transmits an RA message to an ISATAP host in accordance with an exemplary embodiment of the present invention.

Elements in FIG. 10 are similar to those described in FIG. 9. Further, processes where an ISATAP host 101 transmits the first RS message (S1001), and a Network Address Translator (NAT) 102 converts the first RS message into a second RS message and transmits the converted message to the ISATAP router 103 (S1002) are also similar to steps S901 and S902.

The ISATAP router 103 transmits the first RA message 105 (S 1003). The first RA message 105 is also configured with an IPv4 header 105A, an IPv6 header 105B, and data 105C. In this case, a destination address of the IPv4 header 105A is 165.213.223.1 which is an external IPv4 address 73 of a third entry 71C of the mapping table. Further, a destination address of the IPv6 header 105B becomes fe80::5efe:a0a:a0a which is formed by converting 10.10.10.10 being the internal IPv4 address 72 of the third entry 71C of the mapping table into an ISATAP IPv6 address format. Such a first RA message 105 can be routed to the Network Address Translator (NAT) 102 since the destination address of the IPv4 header is the public IPv4 address.

In generating the second RA message 106, the Network Address Translator (NAT) 102 extracts the last 32 bits (a0a:a0a) of the destination address of the IPv6 header 105B of the first RA message 105, that is, an IPv4 address field and converts it into a decimal number (10.10.10.10). The Network Address Translator (NAT) 102 replaces the destination address of the IPv4 header 105A of the first RA message with the converted bit address 10.10.10.10 as the destination address in the IPv4 header 106A of the second RA message 106. The Network Address Translator (NAT) 102 transmits the second RA message 106 generated as described above to the ISATAP host 101 (S1004). The second RA message 106 is also configured with the IPv4 header 106A, an IPv6 header 106B, and data 106C.

While the destination address of the IPv4 header 106A included in the second RA message 106 is the private IP address, the Network Address Translator (NAT) 102 and the ISATAP host 101 are terminals that belong to one private network, so that the second RA message 106 can be transmitted to the ISATAP host 101. Accordingly, the problems in the art which are described in FIG. 5 can be solved.

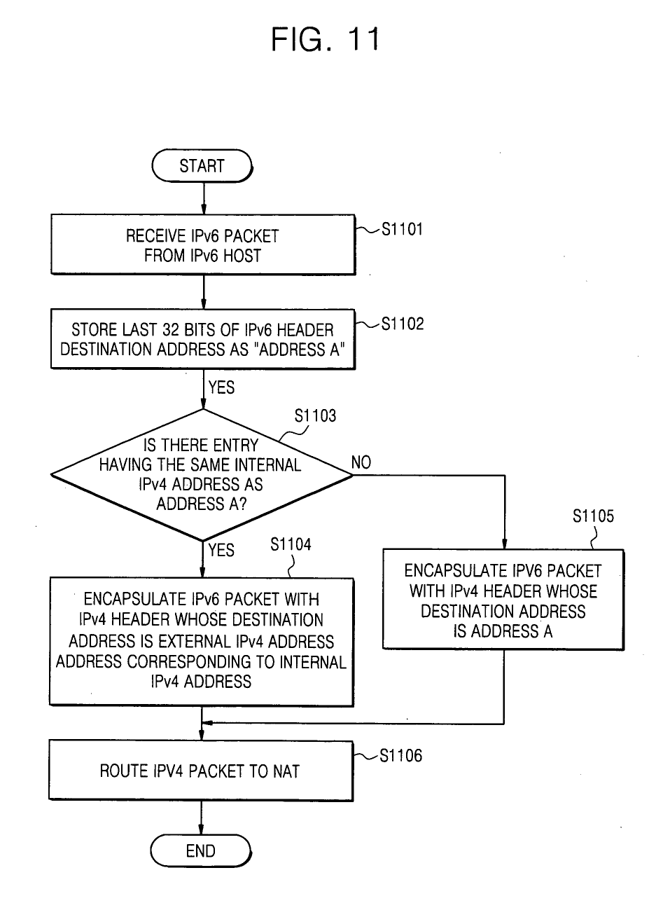

FIG. 11 is a flowchart illustrating a method by which an ISATAP router transmits an IPv6 packet to a Network Address Translator (NAT) in accordance with an exemplary embodiment of the present invention.

The ISATAP router receives an IPv6 packet from an IPv6 host through an ISATAP interface (S1101). The ISATAP router extracts and stores the last 32 bits (hereinafter, referred to as “address A”) among the destination address of the IPv6 header included in the received IPv6 packet (S1102). The ISATAP router searches for whether there is an entry having the same internal IPv4 address as the address A among the mapping table (S1103).

When there is the entry having the same internal IPv4 address as the address A in step S1103, the ISATAP router encapsulates the IPv6 packet within the IPv4 header whose destination address value is the external IPv4 address corresponding to the internal IPv4 address (S1104). The IPv4 packet which is encapsulated according to step S1104 is routed to the Network Address Translator (NAT) (S1106).

When there is no entry which satisfies the condition of S1103, the ISATAP router encapsulates the IPv6 packet within the IPv4 header whose destination address value is the address A (S1105). The IPv4 packet which is encapsulated according to step S1105 is routed to the Network Address Translator (NAT) (S1106).

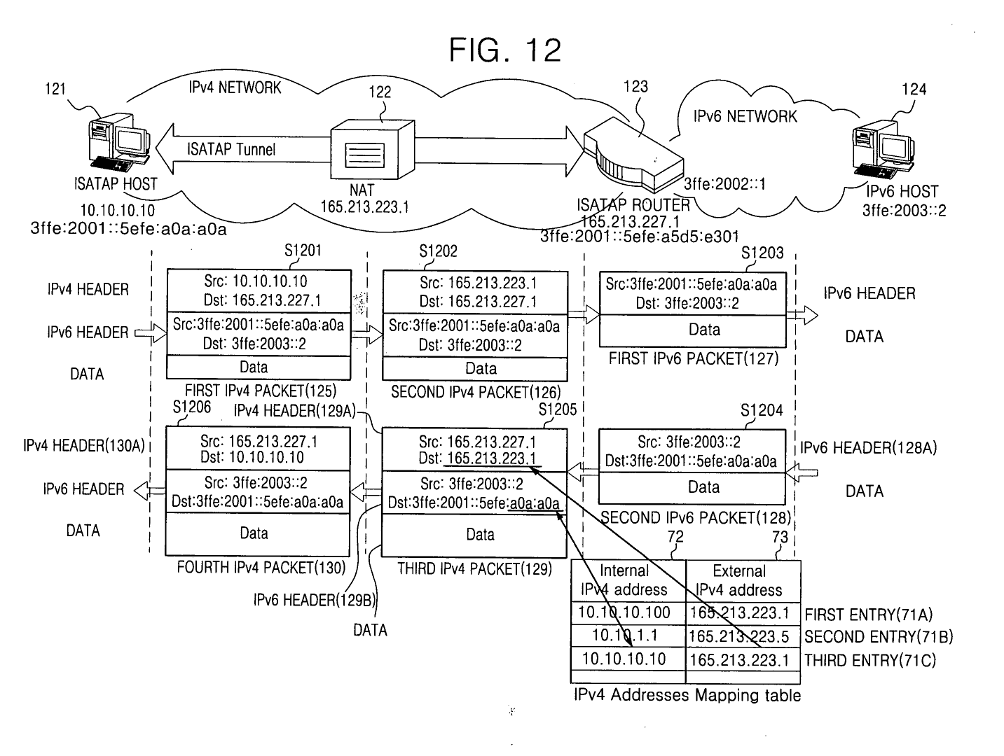

FIG. 12 is a flowchart illustrating steps where an ISATAP host in a Network Address Translator (NAT) area transmits and receives data packets to and from an IPv6 host in accordance with an exemplary embodiment of the present invention.

A network shown in FIG. 12 can be configured with an ISATAP host 121, a Network Address Translator (NAT) 122, an ISATAP router 123 and an IPv6 host 124 similar to those described in FIGS. 9 and 10.

A method by which the ISATAP host 121 transmits data packets to the IPv6 host 123 will be considered. First of all, the ISATAP host 121 makes a transmission (S1201). The Network Address Translator (NAT) 122 converts a first IPv4 packet 125 into a second IPv4 packet 126 (S1202) and transmits the converted packet to the ISATAP router 123. These steps will not be described further since it is similar to steps S901 and S902 in FIG. 9.

The ISATA router 123 decapsulates the IPv4 header of a second IPv4 packet 126, converts it into a first IPv6 packet 127 and transmits the converted packet to an IPv6 host 124 (S1203).

At this time, a method by which the IPv6 host 124 transmits data packets to the ISATAP host 121 will be considered. The IPv6 host 124 transmits the second IPv6 packet 128 to the ISATAP router 123 (S1204). An IPv6 header 128A of the second IPv6 packet 128 has a source IPv6 address (3ffe:2003::2) of the IPv6 host 124, and an IPv6 address 3ffe:2001::5efe:a0a:a0a as a destination address as defined for the ISATAP host 121.

The ISATAP router 123 extracts the last 32 bits (a0a:a0a) among the IPv6 header 128A of the second IPv6 packet 128, and searches the mapping table 70 to check whether there are entries 71A, 71B and 71C having the same internal IPv4 address 72 as the last 32 bits. In FIG. 11, the ISATAP router 123 checks third entry 73C including the address 10.10.10.10 of the same address as the address a0a:a0a.

The ISATAP router 123 has an external IPv4 address value (165.213.223.1) of the third entry 73C as a destination address, and encapsulates the second IPv6 packet 128 within the IPv4 header 129A of third IPv4 packet 129, in which an IPv4 address (165.213.227.1) of the ISATAP router is a source address. The ISATAP router 123 transmits the third IPv4 packet 129 generated in such a method to the Network Address Translator (NAT) 122 (S1205).

The Network Address Translator (NAT) 122 converts the a0a:a0a of the last 32 bits among the destination address of the IPv6 header 129B of the third IPv4 packet 129 into a decimal number (10.10.10.10) and generates a fourth IPv4 packet 130 by utilizing the converted number as the destination address of the IPv4 header 130A. The Network Address Translator (NAT) 122 transmits the fourth IPv4 packet 130 to the ISATAP host 121 using the private IP address (10.10.10.10) (S1206).

Hereinbefore, exemplary embodiments of the present invention have been described. The present invention is not restricted to the embodiments described above, and a variety of modified embodiments will be implemented by those skilled in the art.

For example, according to a scheme to convert a general address and a private address, the Network Address Translator (NAT) can be classified into a static Network Address Translator (NAT) in which a public IPv4 address and a private IPv4 address are matched in 1:1, and a dynamic Network Address Translator (NAT) which is used when the number of the general address is less than that of hosts. The schemes suggested in the present invention can be used regardless of the Network Address Translation (NAT) schemes.

Further, those skilled in the art can apply the schemes in an IPv4/IPv6 conversion mechanism such as a dual stack scheme and a translation scheme as well as various tunneling scheme such as a configured tunnel, an automatic tunnel and 6 to 4 tunnel.

According to the ISATAP router for tunneling packets through the Network Address Translator (NAT) and method thereof in accordance with the present invention, there is provided a router and tunneling method where the private IP address of the ISATAP host and public IPv4 address information are stored in the mapping table, the public IPv4 address of the Network Address Translator (NAT) to transmit the IPv6 packet is checked using the IPv6 packet received from the IPv6 host and the mapping table, and the IPv6 packet is encapsulated within the IPv4 header in which the public IPv4 address of the Network Address Translator (NAT) is the destination address and tunneled to the Network Address Translator (NAT), so that the ISATAP host and the IPv6 network can be connected with each other without changing the Network Address Translator (NAT).

While the present invention has been described with reference to exemplary embodiments thereof, it will be understood by those skilled in the art that various changes in from and detail may be made therein without departing from the scope of the present invention as defined by the following claims.

What is claimed is:

1. A method for configuring tunneling in an IP network, comprising the steps of:
transmitting, at an IPv4 host, to a Network Address Translator (NAT) a first router solicitation message including at lease one of an IPv4 header including a private IPv4 address of the IPv4 host and a public IPv4 address of a router, and an IPv6 header including private IPv4 address information of the IPv4 host;
transmitting, at the Network Address Translator (NAT), to the router a second router solicitation message in which the private IPv4 address of the IPv4 host included in the IPv4 header of the first router solicitation message is replaced by a public IPv4 address of the Network Address Translator (NAT); and
receiving, at the router, the second router solicitation message and store the private IPv4 address of the IPv4 host and the public IPv4 address of the Network Address Translator (NAT) included in the second router solicitation message.

2. The method according to claim 1, wherein the IPv6 header of the first router solicitation message comprises a source address which is an ISATAP IPv6 address of the IPv6 host and a destination address which contains IPv6 address information of the router.

3. The method according to claim 1, wherein the IPv4 header of the first router solicitation message comprises a source address which is a private IPv4 address of the IPv4 host and a destination address which contains public IPv4 address information of the router.

4. The method according to claim 1, further comprising the steps of:
transmitting, at the router, to the Network Address Translator (NAT) a first router advertisement message including at least one of the IPv4 header including the public IPv4 address of the Network Address Translator (NAT) and the public IPv4 address of the router, and the IPv6 header including the private IPv4 address information of the IPv4 host; and
transmitting, at the Network Address Translator (NAT), to the IPv4 host a second router advertisement message in which the public IPv4 address of the Network Address Translator (NAT) included in the IPv4 header of the first router advertisement message is replaced by the private IPv4 address of the IPv4 host.

5. The method according to claim 4, wherein the IPv6 header of the first router advertisement message comprises a source address which is an IPv6 address of the router and a destination address which contains ISATAP IPv6 address information of the IPv4 host.

6. The method according to claim 4, wherein the IPv4 header of the first router advertisement message comprises a source address which is the public IPv4 address of the router and a destination address which contains IPv4 address information of the Network Address Translator (NAT).

7. The method according to claim 1, further comprising the step of:
storing, at the router, an expiration time of the private IPv4 address of the IPv4 host and the public IPv4 address of the Network Address Translator (NAT) corresponding to the private IPv4 address of the IPv4 host.

8. A method for tunneling a packet from an IPv6 host to an IPv4 host, comprising the steps of:
storing, at a router, a private IPv4 address of at least one IPv4 host and public IPv4 address information of a Network Address Translator (NAT) which manages the IPv4 host in a mapping table;
mapping, at the router, the IPv4 address of a receiving IPv4 host included in a header of a first IPv6 packet which is received from a transmitting IPv6 host to the mapping table and to obtain a public IPv4 address of the Network Address Translator (NAT) which manages the receiving IPv4 host;
transmitting, at the router, to the Network Address Translator (NAT) a first IPv4 packet which is formed by encapsulating a header including the public IPv4 address of the Network Address Translator (NAT) of the first IPv6 packet; and
transmitting, at the Network Address Translator (NAT), the first IPv4 packet to the private IPv4 address of the IPv4 host.

9. The method according to claim 8, wherein the step of obtaining, at the router, the public IPv4 address of the Network Address Translator (NAT) comprises the steps of:
extracting, at the router, the last 32 bits of an IPv6 header destination address of the first IPv6 packet; and
searching for, at the router, an entry having the same private IPv4 address of the IPv4 host as the extracted IPv4 address in the mapping table, and obtain a Network Address Translator (NAT) public IPv4 address included in the searched entry.

10. The method according to claim 9, further comprising the sub-step of:
when there is no entry having the same private IPv4 address of the IPv4 host as the extracted IPv4 address, encapsulating, at the router, the header of the first IPv6 packet including the extracted IPv4 address.

11. The method according to claim 8, further comprising the steps of:
transmitting, at the IPv4 host, to the Network Address Translator (NAT) a second IPv4 packet including at least one of the IPv4 header including a private IPv4 address of the IPv4 host and a public IPv4 address of the router, an IPv6 header including the private IPv4 address of the IPv4 host and the IPv6 address of the IPv6 host, and data;
replacing, at the Network Address Translator (NAT), the public IPv4 address of the IPv4 host included in the second IPv4 header by the public IPv4 address of the Network Address Translator (NAT) and transmit the public IPv4 address to the router; and
transmitting, at the router, a second IPv6 packet which is made by decapsulating the second IPv4 header to the IPv6 address of the IPv6 host included in the second IPv6 header (?).

12. A method for tunneling a packet from an IPv6 host to an IPv4 host, comprising the steps of:
transmitting, at an IPv4 host, to a Network Address Translator (NAT) a first router solicitation message including at lease one of an IPv4 header including a private IPv4 address of the IPv4 host and a public IPv4 address of a router, and an IPv6 header including private IPv4 address information of the IPv4 host;
transmitting, at the Network Address Translator (NAT), to the router a second router solicitation message in which the private IPv4 address of the IPv4 host included in the IPv4 header of the first router solicitation message is replaced by a public IPv4 address of the Network Address Translator (NAT);
receiving, at the router, the second router solicitation message and store the private IPv4 address of the IPv4 host and the public IPv4 address of the Network Address Translator (NAT) included in the second router solicitation message in a mapping table;
transmitting, at the router, to the Network Address Translator (NAT) a first router advertisement message including at least one of the IPv4 header including the public IPv4 address of the Network Address Translator (NAT) and the public IPv4 address of the router, and the IPv6 header including the private IPv4 address information of the IPv4 host;
transmitting, at the Network Address Translator (NAT), to the IPv4 host a second router advertisement message in which the public IPv4 address of the Network Address Translator (NAT) included in the IPv4 header of the first router advertisement message is replaced by the private IPv4 address of the IPv4 host;
storing, at a router, a private IPv4 address of at least one IPv4 host and public IPv4 address information of a Network Address Translator (NAT) which controls the IPv4 host in a mapping table;
mapping, at the router, the IPv4 address of a receiving IPv4 host included in a header of a first IPv6 packet which is received from a transmitting IPv6 host to the mapping table and to obtain a public IPv4 address of the Network Address Translator (NAT) which manages the receiving IPv4 host;
transmitting, at the router, to the Network Address Translator (NAT) a first IPv4 packet which is formed by encapsulating a header including the public IPv4 address of the Network Address Translator (NAT) of the first IPv6 packet; and
transmitting, at the Network Address Translator (NAT), the first IPv4 packet to the private IPv4 address of the IPv4 host.

13. The method according to claim 12, further comprising the steps of:
transmitting, at the IPv4 host, to the Network Address Translator (NAT) a second IPv4 packet including at least one of the IPv4 header including an IPv4 address of the IPv4 host and a public IPv4 address of the router, the IPv6 header including the private IPv4 address of the IPv4 host and the IPv6 address of the IPv6 host, and data;
replacing, at the Network Address Translator (NAT), the public IPv4 address of the IPv4 host included in the second IPv4 header by the public IPv4 address of the Network Address Translator (NAT) and transmit the public IPv4 address to the router; and
transmitting, at the router, a second IPv6 packet which is made by decapsulating the second IPv4 header to the IPv6 address of the IPv6 host included in the second IPv6 header.

14. A router for managing at least one IPv4 host and a Network Address Translator (NAT), comprising:
a mapping table including at least one entry including a private IPv4 address of the IPv4 host and a public IPv4 address of a Network Address Translator (NAT) which manages the IPv4 host;
a mapping module for extracting an IPv4 address of a destination IPv4 host from a first IPv6 packet received from an IPv6 host, and searching for a public IPv4 address of the Network Address Translator (NAT) which manages the destination IPv4 host in the mapping table;
a packet conversion module for encapsulating the first IPv6 packet within an IPv4 header including the searched Network Address Translator (NAT) public IPv4 address and converting the encapsulated first IPv6 packet into a first IPv4 packet; and
a communication module for transmitting the converted first IPv4 packet to the public IP address of the Network Address Translator (NAT).

15. The router according to claim 14, wherein the packet conversion module receives the second IPv4 packet to be transmitted from the IPv4 host to the IPv6 host from the Network Address Translator (NAT), decapsulates the second IPv4 header included in the second IPv4 packet and converts the decapsulated IPv4 header into the second IPv6 packet; and
wherein the communication module transmits the converted second IPv6 packet to the IPv6 address of the IPv6 host included in the second IPv6 packet.

16. The router according to claim 14, wherein the mapping table additionally stores an expiration time of each entry.

17. The router according to claim 16, further comprising a mapping table management module for checking whether the expiration time stored in the mapping table has lapsed, and deleting an entry whose expiration time has lapsed.

18. An IP network having an IPv4 host used to communicate with an IPv6 host, comprising:
a router for storing a private IPv4 address of at least one IPv4 host and public IPv4 address information of a Network Address Translator (NAT) which manages the IPv4 host in a mapping table, mapping the IPv4 address of a destination IPv4 host included in a first IPv6 header of a first IPv6 packet which is received from the IPv6 host to the mapping table, obtaining a public IPv4 address of the Network Address Translator (NAT) which manages the destination IPv4 host, and transmitting to the Network Address Translator (NAT) a first IPv4 packet which is formed by encapsulating the first IPv6 packet within an IPv4 header including the Network Address Translator (NAT) public IPv4 address; and
a Network Address Translator (NAT) for transmitting a second IPv4 packet whose address is replaced by a private IPv4 address of the IPv4 host included in the first IPv6 header of the first IPv4 packet to the IPv4 host.

19. The IP network according to claim 18, wherein the router extracts the last 32 bits of an IPv6 header destination address from the received first IPv6 packet, and stores a private IPv4 address of at least one IPv4 host and public IPv4 address information of a Network Address Translator (NAT) which manages the IPv4 host in a mapping table, searches for an entry having the same private IPv4 address as the extracted IPv4 address in the mapping table, and obtains a Network Address Translator (NAT) public IPv4 address which manages the IPv4 host.

20. The IP network according to claim 19, wherein when there is no entry having the same private IPv4 address of the IPv4 host as the extracted IPv4 address, the router encapsulates the header of the first IPv6 packet including the extracted IPv4 address.
